(19) United States
(12) Patent Application Publication
(10) Pub. No.: US 2014/0127655 A1
(43) Pub. Date: May 8, 2014

(54) AIR TRAFFIC MANAGEMENT SYSTEMS AND METHODS

(71) Applicants: Andrew John TAYLOR, Alexandria, VA (US); Lee David ELLIS, Ashburn, VA (US); Daniel Erick PANUSKA, Ashburn, VA (US)

(72) Inventors: Andrew John TAYLOR, Alexandria, VA (US); Lee David ELLIS, Ashburn, VA (US); Daniel Erick PANUSKA, Ashburn, VA (US)

(21) Appl. No.: 14/069,846

(22) Filed: Nov. 1, 2013

Related U.S. Application Data
(60) Provisional application No. 61/721,757, filed on Nov. 2, 2012.

(51) Int. Cl. G09B 19/00; G08G 5/00

(52) U.S. Cl. CPC G09B 19/00; G08G 5/00
USPC 434/220

(57) ABSTRACT

Systems and methods are provided for using speech to control the operation of a training application and executing a training application involving a plurality of trainees. In one implementation, a computer-implemented method is provided for using speech to control the operation of a training application. The method includes receiving audio data representing a response to a training exercise from an input source associated with a trainee. The method processes the received audio data to determine the content of the audio data and generates a command based on at least the processed audio data. The method further processes the generated command to control the operation of the training application.

### CROSS REFERENCE TO RELATED APPLICATIONS

This application claims the benefit of priority of U.S. Provisional Patent Application No. 61/721,757, entitled “AIR TRAFFIC MANAGEMENT SYSTEMS AND METHODS,” filed on Nov. 2, 2012, the disclosure of which is expressly incorporated herein by reference in its entirety.

### BACKGROUND

I. Technical Field

The present disclosure generally relates to air traffic management systems and methods. In particular, the present disclosure relates to systems and methods for using speech to control the operation of a training application and executing the training application for a plurality of trainees.

II. Background Information

The lack of consistent and effective training at many workplaces may result in increased rates of employee attrition and a higher risk of employee underperformance in job-related tasks. In some organizations, such as the Federal Aviation Administration (“FAA”), effective on-the-job training for employees (e.g., controllers and other specialists) is a crucial, yet unfulfilled, need. For example, students who undergo training courses at airports and airspaces are often unable to complete the requisite training needed to adequately perform both simple and complex job-related tasks. Therefore, additional technological tools are needed to improve training in the air traffic management field.

### SUMMARY

Consistent with a disclosed embodiment, a computer-implemented method is provided for using speech to control the operation of a training application. The method includes receiving audio data representing a response to a training exercise from an input source associated with a trainee. The method processes the received audio data to determine the content of the audio data and generates a command based on at least the processed audio data. The method further processes the generated command to control the operation of the training application.

Consistent with a disclosed embodiment, an electronic device is provided for using speech to control the operation of a training application. The system includes a memory storing one or more instructions. The system also includes a processor configured to execute the one or more instructions to perform operations that include receiving audio data representing a response to a training exercise from an input source associated with a trainee. The operations further include processing the received audio data to determine the content of the audio data and generating a command based on at least the processed audio data. In addition, the operations include processing the generated command to control the operation of the training application.

Consistent with a disclosed embodiment, a computer-implemented method is provided for executing a training application involving a plurality of trainees, wherein the plurality of trainees are associated with a plurality of electronic devices, each of the electronic devices configured to execute the training application. The method includes connecting the plurality of trainees to a shared training application using the plurality of electronic devices, wherein each of the electronic devices executes the shared training application and stores a plurality of local objects describing a plurality of states of the associated trainee. The method generates an interactive environment within the shared application, wherein the interactive environment comprises a plurality of global objects describing a plurality of states of the interactive environment. The method updates a value of one or more of the global objects and determines whether conditions for terminating the shared application have been met. The method further updates a value of one or more of the local objects and exchanges data between the electronic devices based on at least the updated local objects.

Consistent with other disclosed embodiments, a non-transitory computer-readable storage media may store program instructions, which are executed by a processor and perform any of the methods described herein.

It is to be understood that both the foregoing general description and the following detailed description are exemplary and explanatory only and are not restrictive of the claims.

### BRIEF DESCRIPTION OF THE DRAWINGS

The accompanying drawings, which are incorporated in and constitute a part of this disclosure, illustrate various disclosed embodiments. In the drawings:

FIG. 1 is an example of a block diagram illustrating a system for providing an air traffic management training application, consistent with disclosed embodiments.

FIGS. 2A, 2B, and 2C illustrate examples of data associated with training applications that can be executed on electronic devices, consistent with disclosed embodiments.

FIGS. 3A, 3B, 3C, 3D, 3E, 3F, 3G(a), 3G(b), 3H, 3I, and 3J illustrate examples of air traffic controller training applications, consistent with disclosed embodiments.

FIG. 4 is a flow diagram illustrating an example of a process for using phraseology to control the operation of training applications, consistent with disclosed embodiments.

FIG. 5 is an example of a block diagram illustrating a system for providing an air traffic management training application, consistent with disclosed embodiments.

FIG. 6 is a flow diagram illustrating examples of a process for executing a training application or software program involving multiple users, consistent with disclosed embodiments.

FIG. 7 is a flow diagram illustrating examples of a process for generating and updating a set of objects in a training application or software program, based on user input, consistent with disclosed embodiments.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions or modifications may be made to the components illustrated in the drawings, and the illustrative methods described herein may be modified by substituting, reordering, removing, or adding blocks to the disclosed methods. Accordingly, the following detailed description is not limiting of the disclosed embodiments. Instead, the proper scope is defined by the appended claims.

Systems consistent with disclosed embodiments provide tools for effective on-the-job employee training by, for example, presenting data sets in a manner to enable students to learn the requisite material. These tools allow students to interact with data sets to retain knowledge of the requisite material and test the students' mastery of the requisite material. For example, in one embodiment, one or more data sets (e.g., aircraft type indicators, route geometries, or phraseology) may be presented to allow a student or trainee to review the data using various interfaces (e.g., in list form or via a “flash card” interface). The student may be able to interact with the data sets by, for example, playing one or more games based on the data sets. The student may test his or her knowledge of the data sets by taking a test in various formats (e.g., fill in the blank, visual recognition, multiple choice question and answer).

Disclosed systems and methods use speech to control the operation of a computer-based training application. In one embodiment, audio data representing a response to a training exercise may be received from an input source associated with a trainee. The received audio data may undergo processing to determine the content of the audio data. For example, the audio data may be in a digital file format and processing of the audio data may include the use of at least one digital signal processing algorithm. Based on at least the processed audio data, a command may be generated. The generated command may undergo processing to control the operation of the training application.

Additional disclosed systems and methods provide a training application for use by a plurality of trainees. Each of the trainees may be associated with an electronic device. In one embodiment, the trainees may interact with a shared training application using his or her electronic device. Each of the electronic devices may execute the shared training application and store a plurality of local objects describing a plurality of states of the trainee who is using the device. An interactive environment may be generated within the shared application. The interactive environment may comprise a plurality of global objects describing a plurality of states of the interactive environment. A value of one or more of the global objects may then be updated. A determination may be made as to whether conditions for terminating the shared application have been met. A value of one or more of the local objects may be updated and, based on at least the updated local objects, data may be exchanged between the electronic devices.

Systems and methods are also disclosed for generating an interactive environment. An example of an interactive environment may include a pseudo-real-time environment. In one embodiment, a processor may read data describing an interactive environment. The data may include, for example, configuration data such as airspace volume, route information, control procedures, modifications to control procedures, and airline information. Updates to the data may be received on a regular basis. The updates may be used to keep the interactive environment current. After reading the data, the processor may render the interactive environment based on the data. The rendered interactive environment may be analyzed based on at least a plurality of geometric constraints. Geometric constraints may include, for example, the formation of contiguous regions and shapes, proper overlapping of geometric blocks, and valid designation of control regions in the geometric space. Based on at least the performed analysis described above, the rendered environment may then be modified as needed.

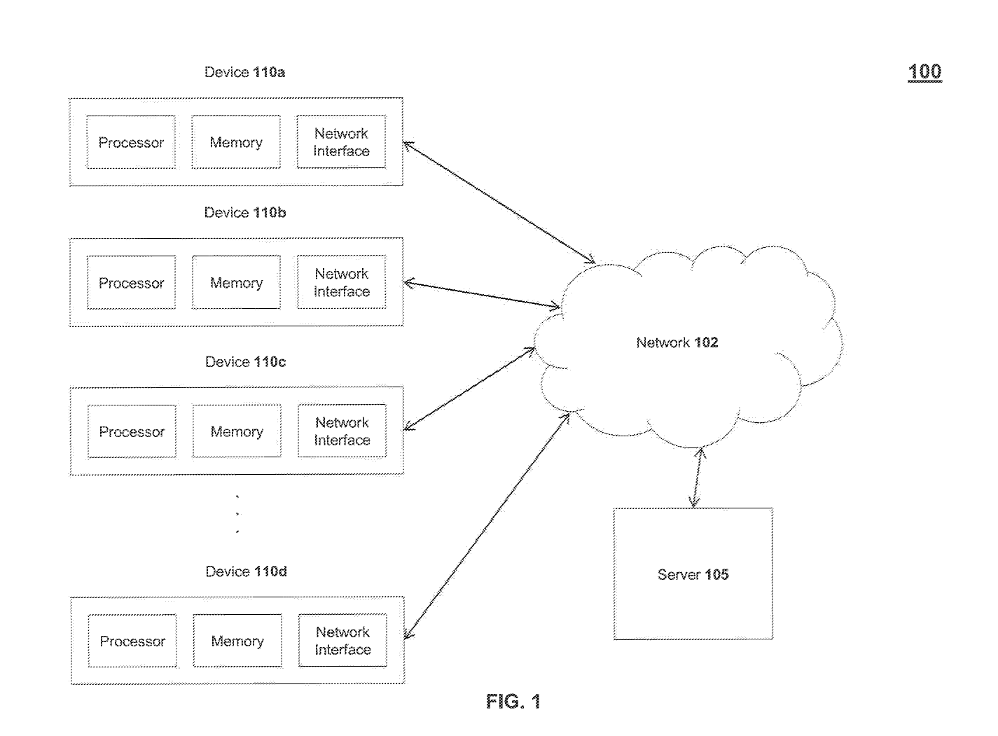

FIG. 1 is a block diagram of a network system 100, consistent with disclosed embodiments. FIG. 1 shows one or more users operating devices 110a-d, which are in communication with a network 102. Network 102 provides communications between the various components in system 100. Network 102 may be a shared, public, or private network, may encompass a wide area or local area, and may be implemented through any suitable combination of wired and/or wireless communication networks. Network 102 may further comprise an intranet or the Internet.

Devices 110a-110d may include one or more computers, tablet computers, cellular phones (including “smart phones”), and other mobile or portable electronic devices capable of communicating over network 102 and/or connecting to other devices. Devices 110a-110d may include a processor (such as any of a number of processors manufactured by Intel™, AMD™, or Sun Microsystems), a memory (which may include one or more storage devices configured to store information used by the processor), a network interface, and one or more input devices (e.g., microphone, keyboard, mouse) (not shown). The configuration and number of processors, memory devices, network interface devices, and input devices may vary as appropriate for certain embodiments. In one exemplary embodiment, devices 110a-110d may include iPads (or similar tablet computers, such as Android-based tablets) configured to execute training applications for students.

System 100 may include server 105 connected to network 102. In some embodiments, may be a centralized server acting as an intermediary between devices 110a-d. Server 105 may include one or more processors, memory devices, network interface devices, and input devices. Additionally, server 105 may execute program instructions configured to transmit data between devices 110a-110d.

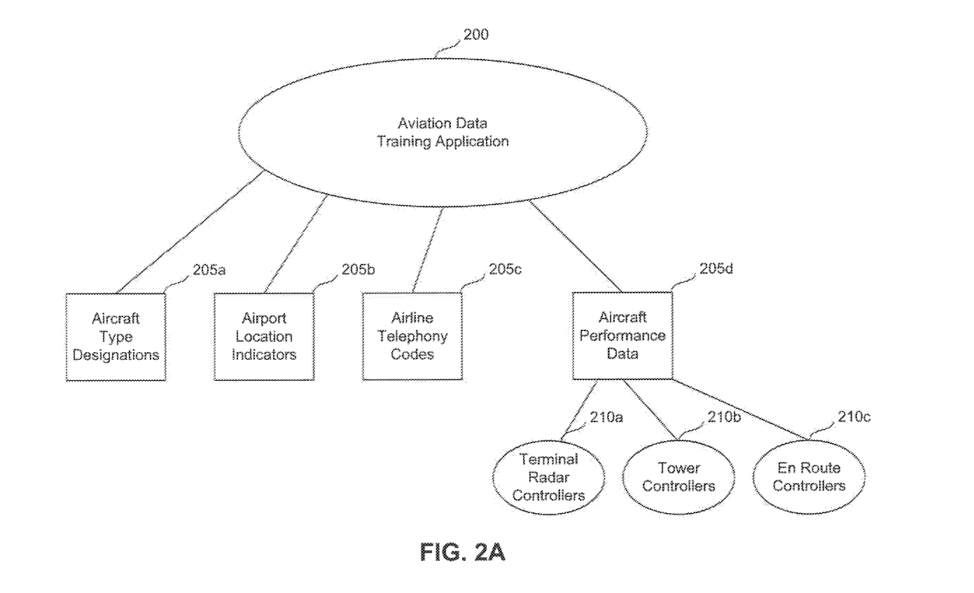

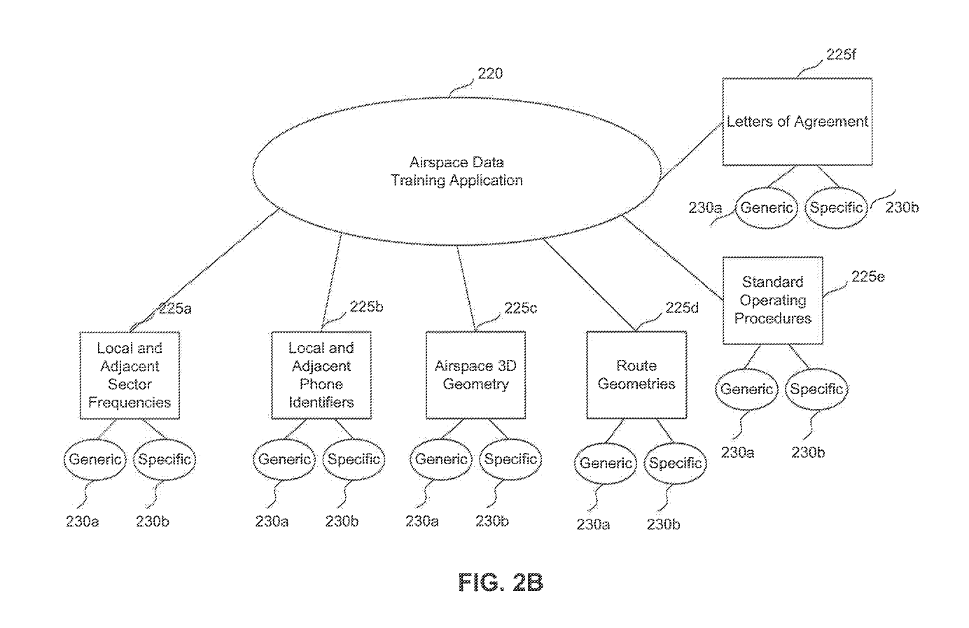

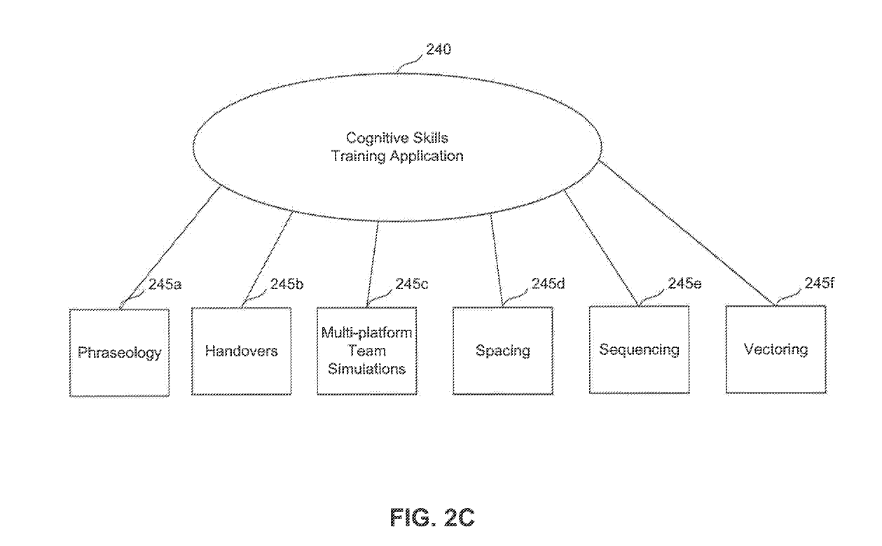

FIGS. 2A, 2B, and 2C illustrate examples of training applications that can be executed on devices 110a-110d (e.g., tablet computers such as iPads or Android-based tablets, and so forth) and other devices. Users of the training applications are able to learn about various data sets (e.g., by using lists, flash cards, maps, route segments, tables, charts, documents, and so forth), interact with information in those data sets (e.g., by playing games, such as memory, sorting, or mapping games), and test their knowledge of the information in those data sets (e.g., by taking tests in a multiple choice or data entry format).

FIG. 2A is a schematic representation of data associated with an aviation data training application 200. Aviation data training application 200 includes basic aviation data necessary to become an air traffic controller or other aviation professional. Users may use aviation data training application 200 to learn about data sets including, for example, aircraft type designators 205a, airport location indicators 205b, and airline telephony codes and calisigns 205c. Information in these data sets may be derived from International Civil Aviation Organization (ICAO) designations or codes, and/or from International Air Transport Association (IATA) designations or codes.

Aviation data training application 200 may further include data sets directed to aircraft performance data 205d. Aircraft performance data 205d may include information on: (i) aircraft characteristics for terminal radar controllers 210a (e.g., weight class, aircraft model designators, climb rates, cruise speeds, approach speeds, descent rates, and Land and Hold Short Operations (LAHSO) groups); (ii) aircraft characteristics for tower controllers 210b (e.g., visual identifiers, weight class, aircraft model designators, climb rates, approach speeds, LAHSO groups, and Same Runway Separation (SRS) categories); and (iii) aircraft characteristics for en route controllers 210c (e.g., weight class, aircraft model designators, climb rates, cruise speeds, and descent rates). More generally, the data sets included in the aviation data training application 200 may be divided into categories such as state, region, country, “top 100 airports in the world,” “top 35 airports in the United States,” and so forth.

FIG. 2B is a schematic illustration of data associated with an airspace data training application 220. The data sets in airspace data training application 220 may include, for example, local and adjacent sector frequencies (UHF and VHF) 225a, local and adjacent phone identifiers and numbers 225b, airspace 3D geometry 225c, standard operating procedures for the airspace 225e, and letters of agreement for the airspace 225f. In addition, airspace data training application 220 may include information on route geometries 225d, such as bearings, distances, waypoints, route identifiers, and directional status.

As illustrated in FIG. 2B, the data sets in airspace data training application 220 may correspond to either generic airspaces 230a or specific airspaces 230b. A generic airspace may refer to an airspace featuring a geometrical attributes common to many academic institutions and the FAA, such that the airspace data is relatively fixed and unlikely to substantially change over time. An example of such an airspace is Sector 66 of the FAA NAS airspace in Memphis, Tenn. The generic airspace may be tweaked to simplify procedures and engineer specific air traffic scenarios. In contrast, airspace data training application 220 may be configured to regularly check for and download updates for information on specific airspaces, such as every 56 days per the Aeronautical Information Regulation And Control (AIRAC) cycle.

FIG. 2C is a schematic illustration of data associated with a cognitive skills training application 240 that is based on certain cognitive skill sets needed to become an air traffic controller. Cognitive skills training application 240 may include functionality (or sub-applications) for phraseology, handovers, multi-platform team simulations, spacing, sequencing, and vectoring, as illustrated in FIG. 2C.

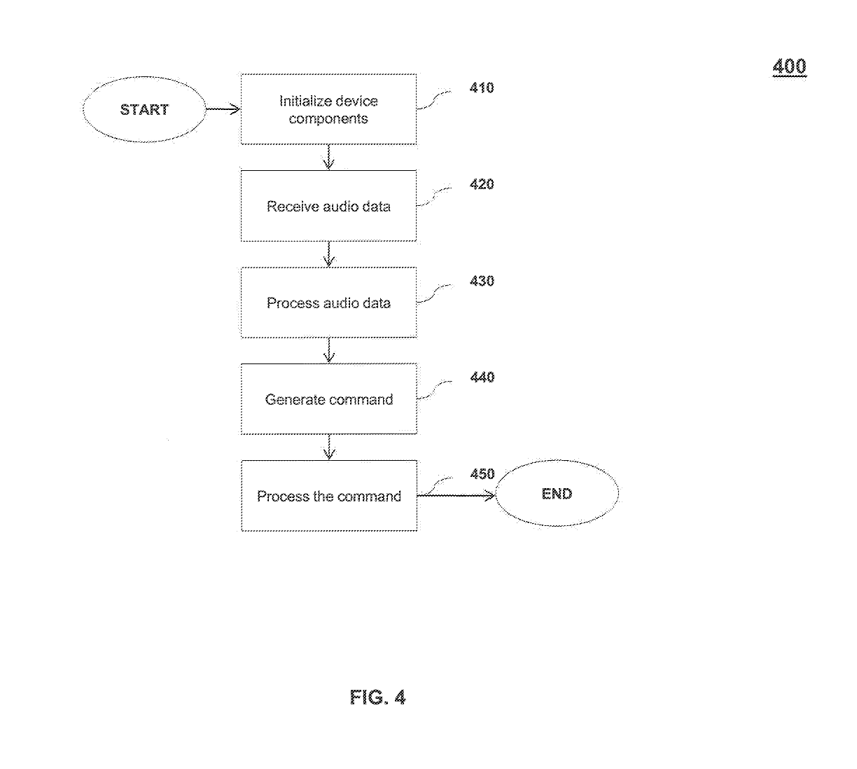

“Phraseology” 245a may include the user speaking certain voice commands (through the use of a microphone and headset) that will be deciphered and ranked to provide feedback on the correctness of the instructions provided. Phraseology is further described in connection with FIG. 4, below. “Handovers” 245b refers to syntax for handing over specific aircraft configurations as defined, for example, by ICAO. This functionality may require the user to speak or enter the correct phraseology in the correct order. “Multi-platform team simulations” 245c allows users to practice aircraft control mechanisms on their own tablet or other electronic device, while requiring each user to employ verbal or automated coordination to communicate with the other users, for example, that an aircraft is leaving one sector and is entering another sector. “Spacing” 245d requires users to vary the speed of an aircraft as quickly as possible to provide the correct spacing for an aircraft to proceed through a sequence of crossing traffic. Similarly, “sequencing” 245e requires users to vary the speed of an aircraft as quickly as possible to provide the correct spacing for merging into a sequence of traffic. In addition, “vectoring” 245f requires users to vary the direction of an aircraft as quickly as possible to provide the correct separation for an aircraft to proceed through a sequence of crossing traffic. Spacing, sequencing, and vectoring may be configured to permit changes to factors such as wind speed, direction, and orientation, thereby increasing the complexity.

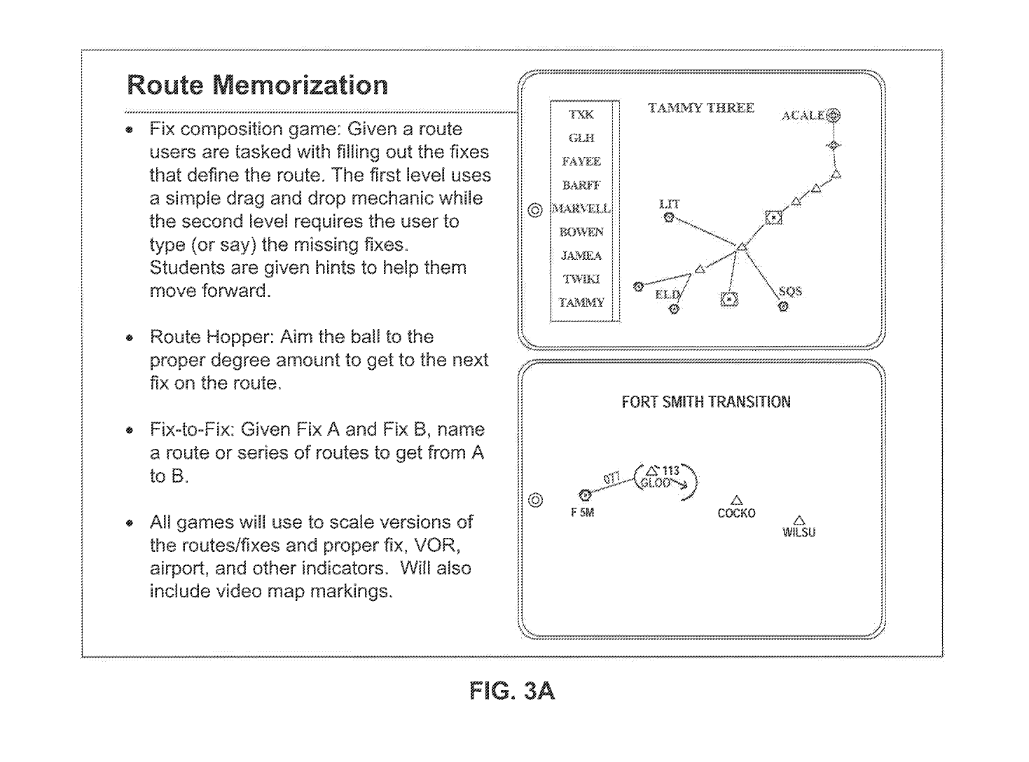

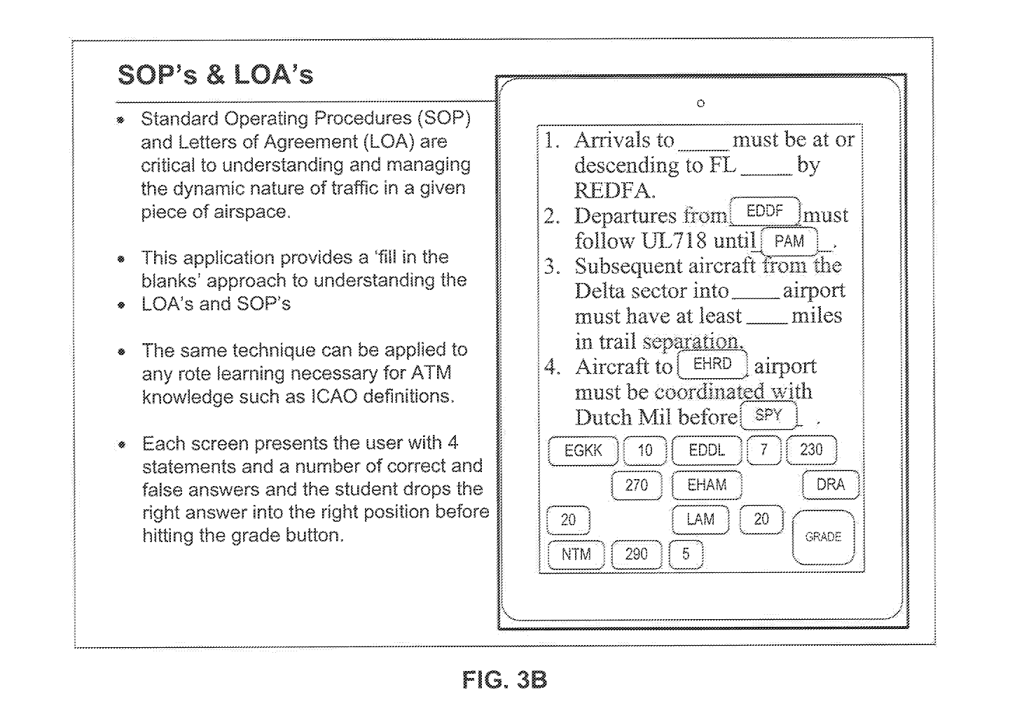

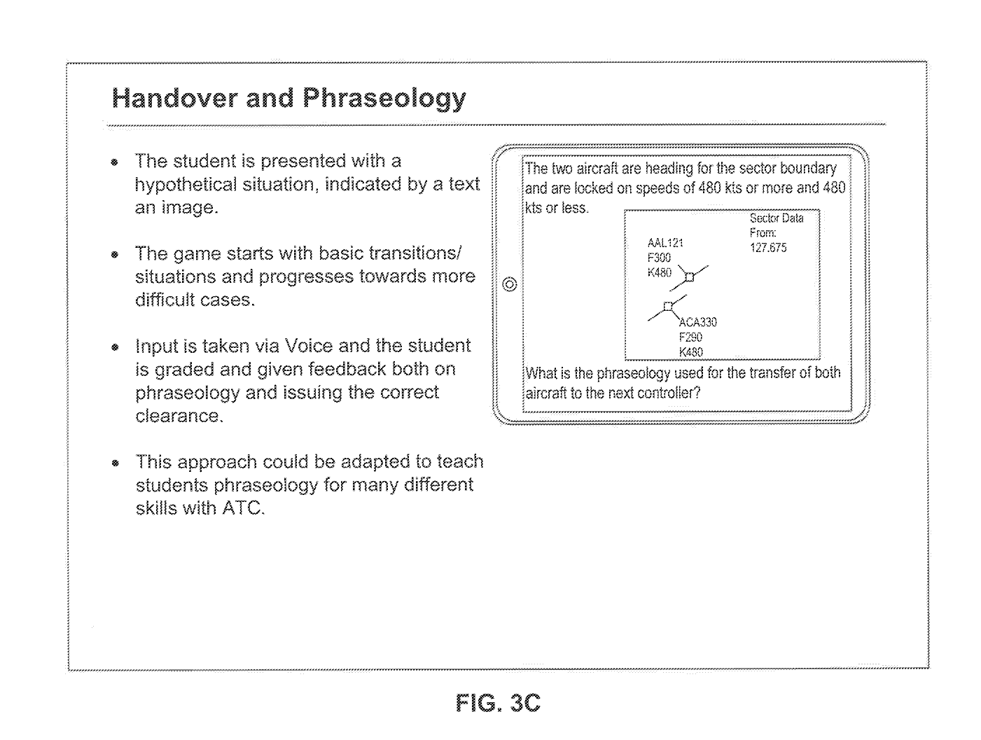

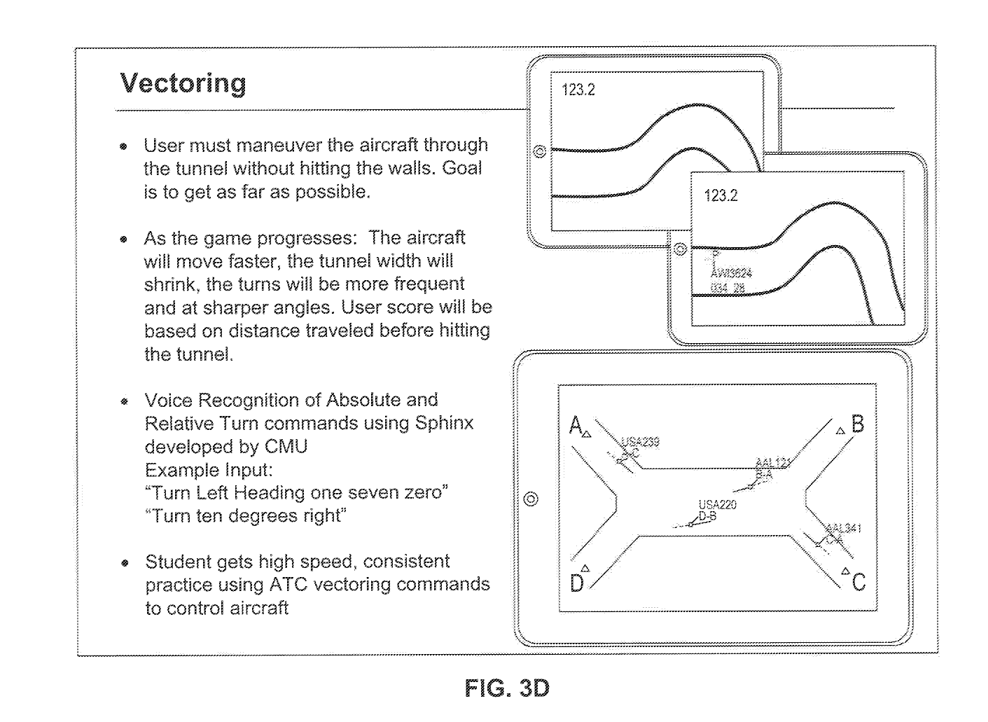

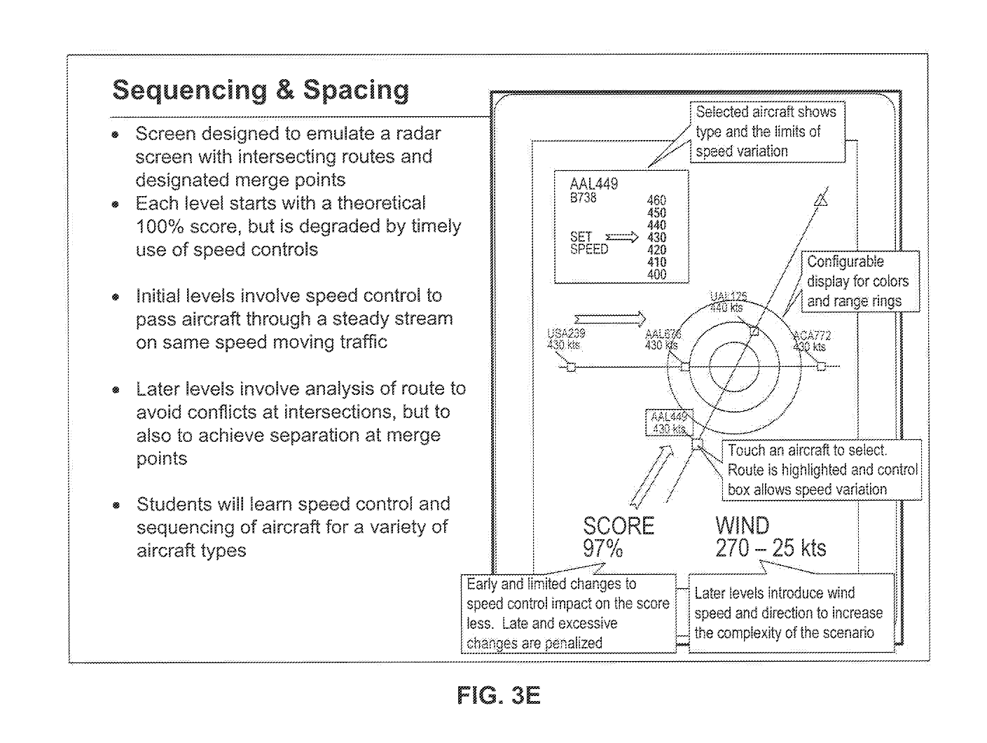

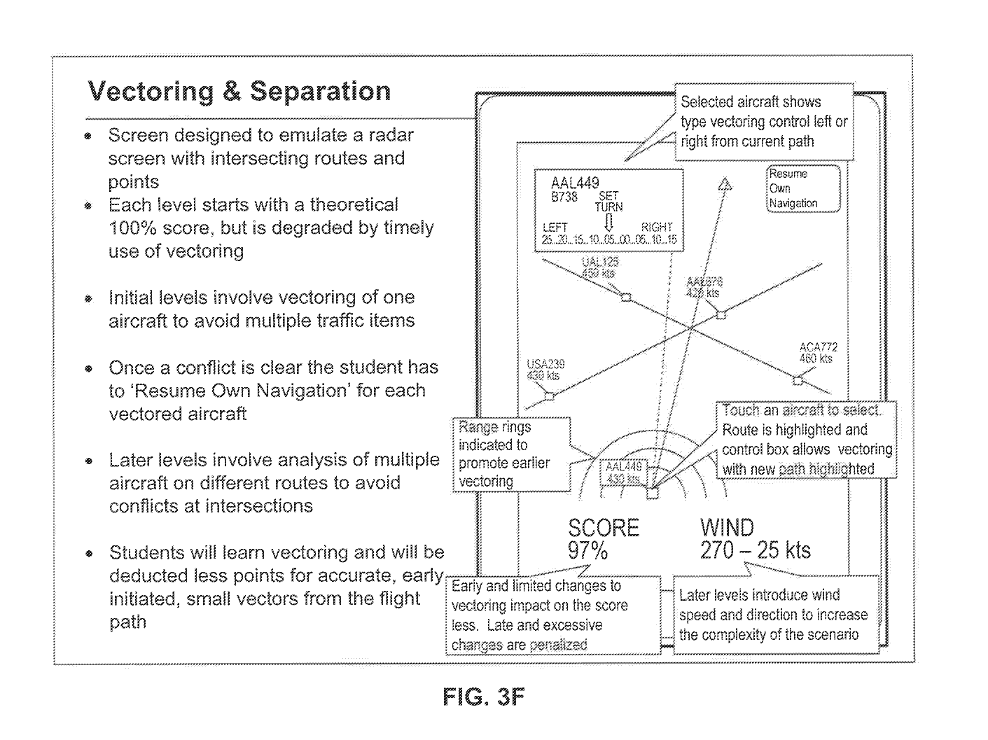

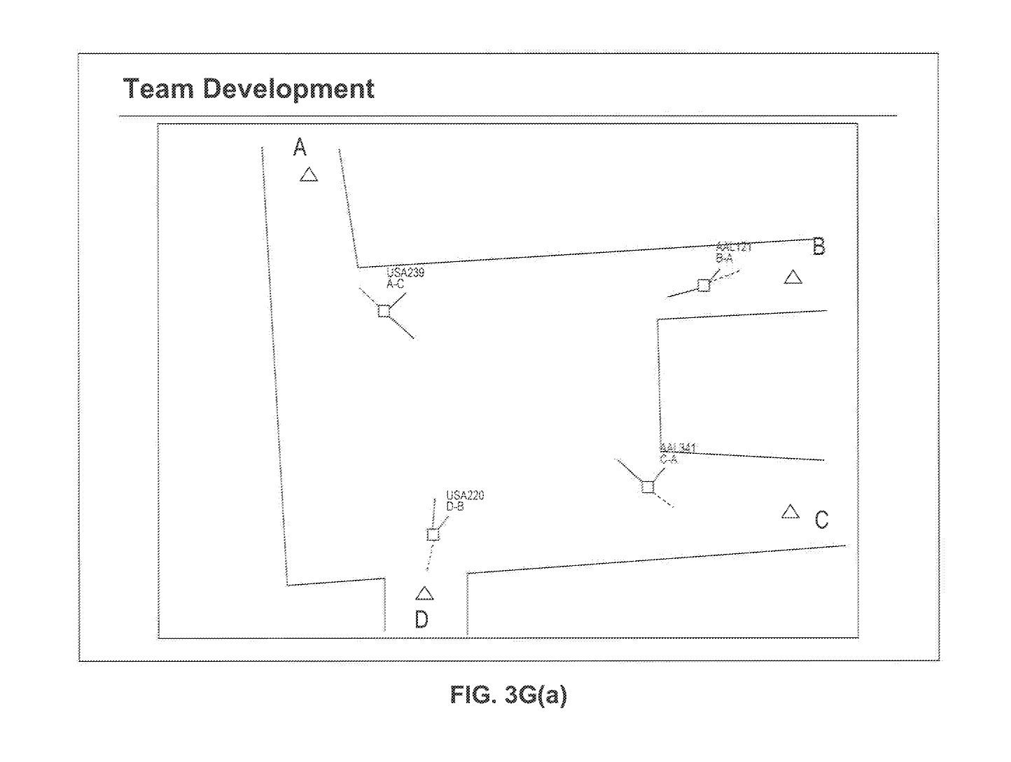

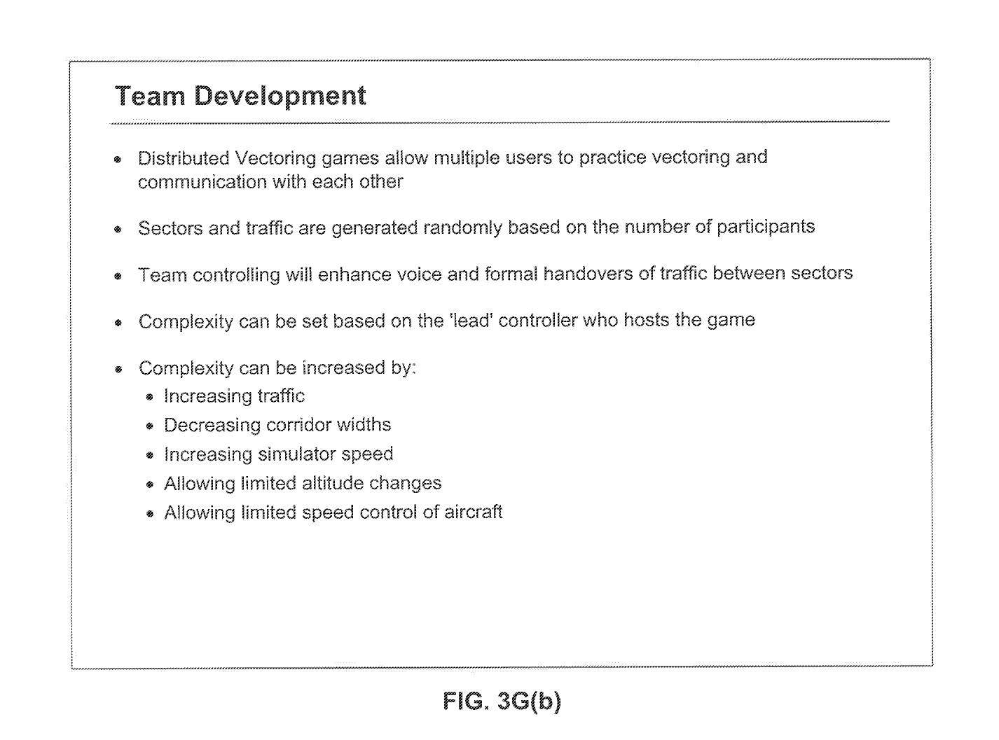

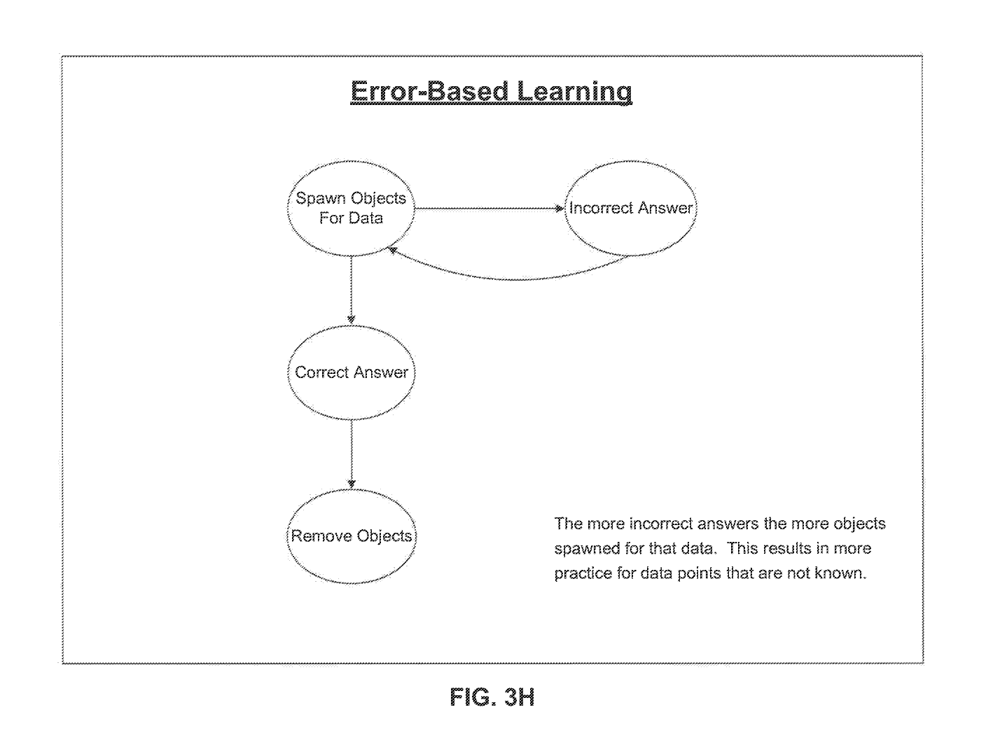

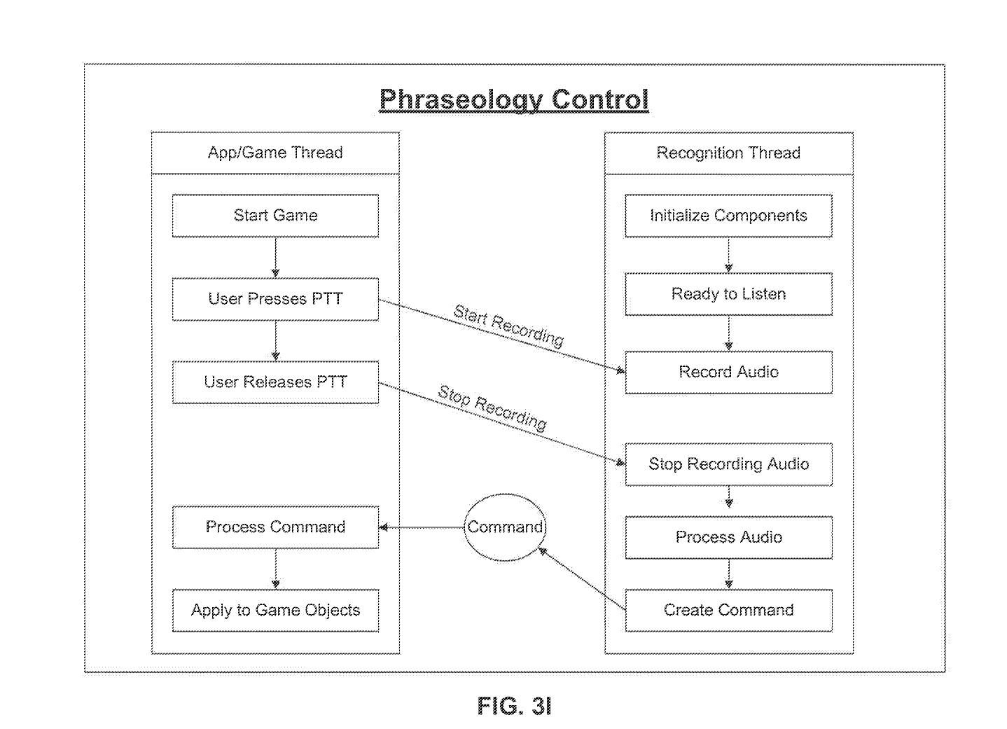

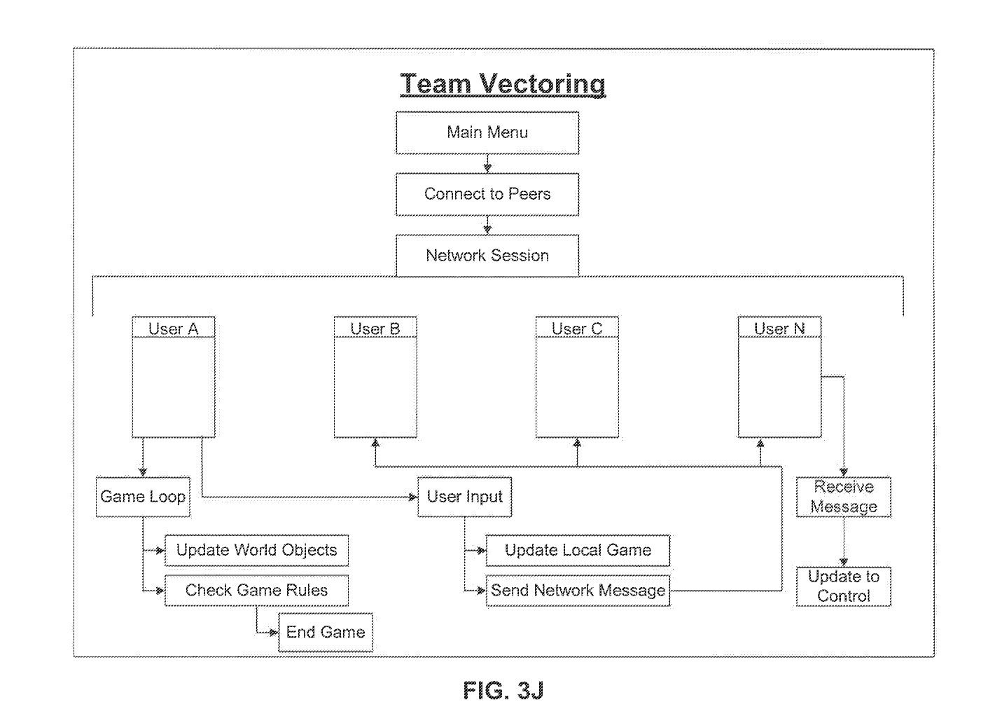

FIGS. 3A, 3B, 3C, 3D, 3E, 3F, 3G(a), 3G(b), 3H, 3I, and 3J illustrate examples of air traffic controller training applications. The air traffic controller applications may provide functionality for different learning and interactive applications, such as error-based learning, route memorization games, team-based vectoring games, and so forth.

FIG. 3A depicts route memorization games, including: (i) a “fix composition” game that requires a user to fill out the fixes that define a route, (ii) a “route hopper” game that prompts a user to aim a ball at a certain degree to get to the next fix on a route, and (iii) a “fix-to-fix” game that requires a user to name a route or series of routes to get from fix A to fix B.

FIG. 3B illustrates a training application directed to standard operating procedures (SOPs) and letters of agreement (LOAs) that provides a user with a “fill in the blanks” approach to learning and understanding SOPs and LOAs.

FIG. 3C illustrates a training application that presents a user with hypothetical situations (described using text and images) and requires the user to input the appropriate voice commands in response to the hypotheticals.

FIG. 3D depicts a vectoring game involving users maneuvering aircraft through a tunnel without hitting the tunnel walls. Users input voice commands (such as “turn ten degrees right”) to maneuver the aircraft and, as the game progresses, the difficulty increases by, for example, shrinking the width of the tunnel, creating more frequent and sharper turns, and increasing the speed of the aircraft.

FIG. 3E depicts a sequencing and spacing game that is designed to emulate a radar screen with intersecting routes and designated merge points. Users must control the speed of the aircraft and analyze the routes to navigate selected aircraft through a stream of traffic.

FIG. 3F depicts a vectoring and separation game involving vectoring of aircraft to avoid multiple traffic items and analysis of multiple aircraft on different routes to avoid conflicts at intersections. Later levels introduce wind speed and direction to increase the complexity of the game.

FIGS. 3G(a) and 3G(b) demonstrate distributed vectoring games in which multiple users practice vectoring and communication with one another. Sectors and traffic are generated randomly based on the number of users, and the game complexity can be increased by increasing traffic, decreasing corridor widths, increasing simulator speeds, allowing limited altitude changes, and/or allowing limited speed control of aircraft.

FIG. 3H illustrates an exemplary process flow for error-based learning in air traffic controller training applications. The process includes generating additional objects from a given data set based on incorrect student answers.

FIG. 3I illustrates an exemplary process flow for phraseology control in air traffic controller training applications. The process includes creating and processing commands based on recorded audio, such as voice input from a student.

FIG. 3J illustrates an exemplary process flow for team vectoring in air traffic controller training applications. The process includes running a game loop involving multiple students until a set of game rules have been satisfied.

FIG. 4 is a flow diagram illustrating a process 400 for using phraseology to control the operation of a training application. The training application may include, for example, route memorization games, sequencing, spacing, and vectoring applications, and so forth. The training application may be executed on one or more devices 110a-110d or executed by server 105. In some embodiments, modules of the training application may be provided by one or more devices 110a-110d in conjunction with server 105.

At step 410, the training application may first initialize one or more system components of an electronic device, such as operating device 110a, including, for example, computer hardware or software-based objects. Specifically, the training application may identify internal (e.g., built-in) and external devices of device 110a capable of recording audio data and initialize hardware found in the identified devices. Additionally, the training application may record a sample of audio data and determine, based on the sample, a baseline noise calculation. The calculation may be performed in order to enable more effective processing of audio data. The training application may then receive audio data at step 420, such as an audio stream or a digital voice recording, in any of a number of digital file formats (e.g., “.wav,” “.aiff,” “.mp3,” “.flac,” or “.wma”). The audio data may be received from various input sources, including, for example, a microphone or an input file. At step 430, the received audio data may then be processed. In some embodiments, processing of the input file may include the application of any number of digital signal processing algorithms to the audio data. Such algorithms may include a “Fourier transform,” “Discrete Fourier transform,” “Fast Fourier transform,” “Inverse Fourier transform,” “Hilbert transform,” or any other suitable signal processing algorithm. In some embodiments, processing the audio data may include comparing the audio data content against words stored in a dictionary. In the case where the comparison results in a match between the processed audio data and one or more words in the dictionary, the training application may generate a command based on the match, as will be further described below.

The training application may generate a command at step 440. The command may be generated based on, for example, the processing of the audio data at step 430. Furthermore, the command may be generated based on context and the expected language of the domain. As will be explained below, the context and expected language of the domain may depend on the type of training application. In some embodiments, the processed audio data may be compared to words stored in a lookup-table or a similar data structure, where the stored words correspond to instructions or commands that affect the operation of a training application. Thus, the command may be generated based on a match between the processed audio data and a word in the lookup table, in which case the processed audio data is determined to be a valid instruction. Additionally, in certain embodiments, the command may be generated based on the closest match if an exact match is unavailable. For instance, the processed audio data “turn left 30” may be determined to correspond to the stored instruction “turn left 30 degrees,” even though the match is not exact. In the case where an exact match and closest match are unavailable, the user may be notified that the instruction is invalid.

Next, the training application may process the generated command at step 450. In some embodiments, processing the generated command may include executing certain operations or instructions corresponding to the command. In the case of the command “turn left 30 degrees,” for example, the aircraft route or trajectory may be shifted 30 degrees counter-clockwise. Furthermore, in some embodiments, the training application may provide feedback to a user concerning incomplete recognition or recognition failures. The feedback may, for example, guide the user towards successfully providing a command that is recognized by the system.

In one exemplary embodiment, the method of FIG. 4 may enable students to practice the use of “phraseology,” i.e., terminology that is particular to a field of endeavor, such as aviation or aviation control. For example, the method of FIG. 4 may recognize only specific phrases spoken by a student when using a training application. In some embodiments, no other combination of the words will suffice and the exact phraseology is required to interact with the application. This serves as an effective training and testing tool by requiring the student to practice the use of phraseology that he or she will need to successfully perform job-related functions, such as guiding aircraft during takeoff or landing, or communicating with controllers, pilots, and other aviation personnel. In another exemplary embodiment, the method of FIG. 4 may enable students to practice phraseology in various contexts such as, for example, vectoring. A vectoring training application may involve guiding or navigating a moving object through a course, such as a two-dimensional tunnel. Therefore, in the context of vectoring, students may practice directional phraseology by providing commands such as “turn left 30 degrees.”

Exemplary pseudocode for “vectoring” may be described as follows: “Present_Menu( )”: “Look_For_Peers( )” (devices look for peers over bluetooth, local network, or the internet) and “Connect_To_Peers( )” (establish a connection with other users); “Start_Game( );”; “Initiliaze_World( );” (setup the airspace presented to each user and synchronize) and “Initialize_Interface( );” (setup all interactive controls for the user); “Play_Game( );”: “Begin_Update_Loop( );” (update all world objects at a predetermined rate) and “Check_Game_State( );” (apply game logic, move world objects, check rule set for end of game scenarios); “On_User_Input( );” (the user has given a command through the interface): “Send_Network_Message( );” (notify all connected peers of the users actions) and “Receive_Network_Message( );” (apply updates locally, add or modify world objects as necessary).

In one implementation, a dictionary of desired air traffic controller phraseology is formed based on phonetic sounds, which form a list of possible recognized words. The basic dictionary contains directions (e.g., “left,” “right”), numerical values (e.g., “one,” “two,” “three,” “four,” “five,” “six,” “seven,” “eight” “nine,” “zero”) as well as other expected words (e.g., “turn,” “heading,” “degrees”). The expected vocal combinations may be expressed using a Backus-Naur Form style language called “Java Speech Grammar Format” (JSGF). The grammar defines the acceptable combinations of words into commands. The dictionary and grammar are then fed into a speech processing library, such as the “Pocket Sphinx” library. All processing and recording is done in a separate background thread.

In the exemplary pseudocode appearing below, “PTT” is defined as a user interface control that mimics “push-to-talk” functionality present in a controller environment.

Exemplary pseudocode for implementing the use of “phraseology” may be described as follows: “Initialize_Recording_Components( );” (noise cancellation and other calibrations); “Start_Listening_Loop( );” (begin a buffered queue of audio packets); “Pause_Listening_Loop( );” (only listen when the user presses the button); On_User_Pressed_PTT: “Resume_Listening_Loop( );” (start gathering audio packets); On_User_Released_PTT: “Pause Listening_Loop( );” (stop gathering audio packets) and “Process_Recorded_Data( );” (send recorded data to Recognition Library); “Command=Process_Results( )” (use confidence level and hypothesis to form an air traffic controller command); “Apply_Command( );” (apply command to aircraft/other objects).

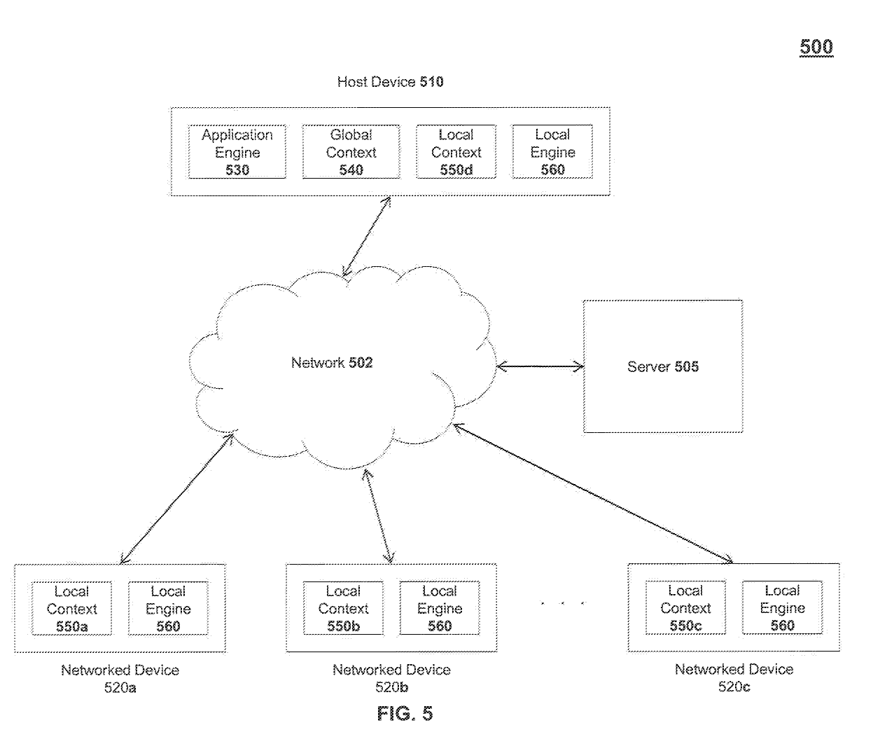

FIG. 5 is a block diagram of a system 500 consistent with disclosed embodiments. FIG. 5 shows a host device 510 and one or more networked devices 520 connected to a server 505 through a network 502. Network 502 may be similar to network 102, discussed above in connection with FIG. 1. For example, devices 510 and 520a-c may be connected through a local area network, the internet, or through other wired and wireless connection mechanisms, such as Bluetooth. Similar to devices 110a-110d of FIG. 1, the host device 510 and networked devices 520a-c may include one or more computers, tablet computers, cellular phones (including “smart phones”), and other mobile or portable electronic devices capable of communicating over a network or connecting to other devices. Also, similar to the networked device 110 of FIG. 1, the host device 510 and networked devices 520a-c may include a processor (not shown) (e.g., any of a number of processors manufactured by Intel™, AMD™, or Sun Microsystems), a memory (which may include one or more storage devices configured to store information used by the processor) (not shown), a network interface (not shown), and one or more input devices (e.g., microphone, keyboard, mouse) (not shown).

Server 505 may be a centralized server acting as an intermediary between devices 510 and 520a-c. Server 505 may include one or more processors, memory devices, network interface devices, and input devices. Additionally, server 505 may execute program instructions configured to transmit data between devices 510 and 520a-c.

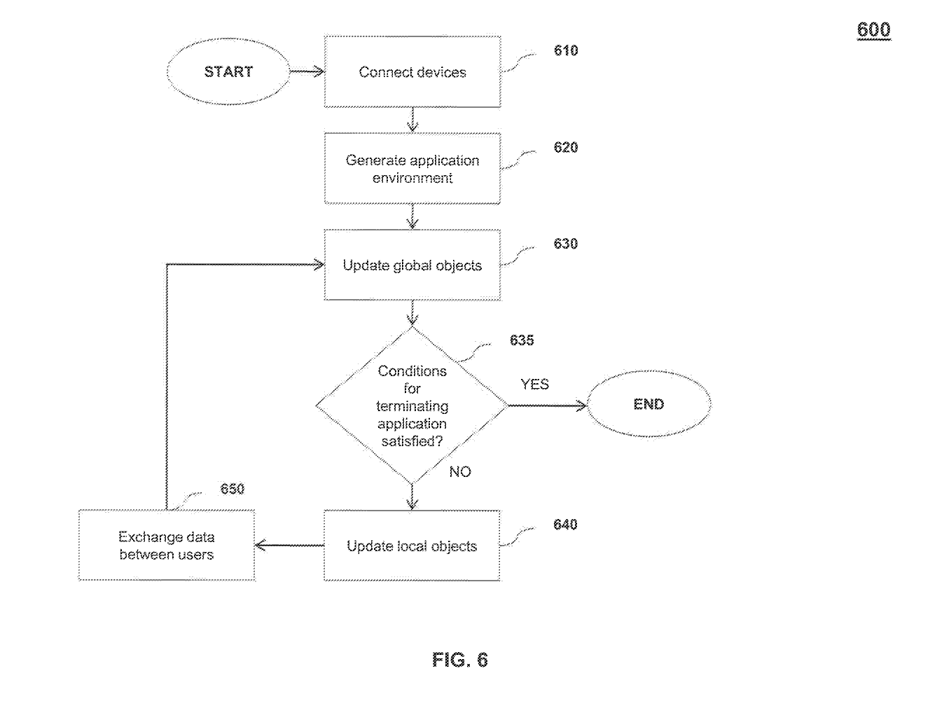

Consistent with disclosed embodiments, an application engine 530 of host device 510 may initiate execution of an application, and networked devices 520a-c may connect to host device 510 via network 502. The application may include one or more training programs such as, for example, a program for teaching users a data set, a program for allowing users to interact with a data set, and a program for testing users on a data set. Furthermore, the application may include a global set of objects or variables, for example, world state objects and other data pertinent to multiple users, as represented by global context 540. In addition, each of the host device 510 and networked devices 520a-c may include a local set of objects or variables, as represented by local context 550a-d. Application engine 530 may update or modify global context 540 during execution of the application. Similarly, local engine 560 may update or modify local context 550a-d during execution of the application. Additional details regarding updating the global context 540 and local context 550a-d are described in connection with FIG. 6, below.

In one exemplary embodiment of the system illustrated in FIG. 5, host device 510 and networked devices 520a-520c may include iPads (or similar tablet computers, such as Android-based tablets) configured to execute training applications for students. Each of the devices may include a processor (not configured to execute software developed to run on iPads (and other table computers), as represented by application engine 530 and local engine 560. That is, application engine 530 and local engine 560 may be a part of a training application, or may be software designed to interface with a training application. Each of the devices may also include a memory (not pictured) configured to store, and update, global context 540 and local context 550a-d. Global context 540 and local context 550a-d may collectively include sets of variables describing the status of execution of a training application. For example, the training application may include a team aircraft simulation involving multiple students, where the objective may be to safely guide one or more aircraft through coordination and communication between the students. In such a simulation, global context 540 may describe the status of the aircraft (e.g., aircraft coordinates and speed, aircraft identification information, and environmental variables such as wind and weather), while local context 550a-d may describe the status of a local environment associated with each student (e.g., the history of actions taken by each student, the current actions available to each student, and the status of input and output variables for each student).

FIG. 6 is a flow diagram illustrating an example of a process 600 for executing a training application involving multiple users. The training application may be executed on one or more devices 510 and 520a-c, or executed by server 505. In some embodiments, modules of the training application may be provided by one or more devices 510 and 520a-c in conjunction with server 505.

At step 610, the devices may connect to server 505 through network 502, as described above in connection with FIG. 5. Server 505 may also establish a networking session between the devices which may include, for example, configuring network and user-specific variables and setting permissions or control settings. A synchronized clock may also be established following creation of the networking session.

The training application may generate an application environment at step 620. In some embodiments, generation of an application environment may include, for example, creation of a continuous airspace spanning multiple platforms (e.g., mobile electronic devices). Various configuration data may be used to generate the environment, including, for example, airspace volume data (e.g., portions of an airspace assigned to an individual or prohibited from use), updated route data, updated fixes (fixes are added and renamed regularly to support new control procedures), and updated airline data. In some embodiments, 3D geometric analysis is performed to validate the airspace blocks of a particular facility by, for example, checking that the airspace blocks form a contiguous shape. For instance, there may be “holes” or spaces lacking an official control entity, and there may be situations where, for a portion of the airspace, multiple blocks overlap.

Next, at step 630, the training application may update global objects or variables as needed. Global objects may be included in a global context, as described above in connection with FIG. 5. In some embodiments, global objects may include state variables representing a status or a phase of the application. Such state variables may be evaluated, for example, at step 635, to determine whether execution of an application has completed and whether the application should then be terminated. The global objects may be checked against a set of rules to determine whether execution of an application has completed. If conditions for terminating the application have not been met, local objects or variables, (which may be included in a local context, as described above in connection with FIG. 5) may be updated or modified at step 640. In some embodiments, local objects may include state variables representing a status of a user involved in the application. Next, at step 650, local objects may be used to exchange data between devices. For example, the training application may transmit local context data, such as the history of actions taken by each student, the current actions available to each student, and the status of input and output variables for each student, between devices 510 and 520a-c. Following the exchange of data, the training application may once again update or modify the global objects at step 630.

According to process 600, multiple students may be involved in a training application together, such as the team aircraft simulation described above in connection with FIG. 5. Continuing with the team aircraft simulation as an example, the method of FIG. 6 may generate the environment for the simulation including, for example, multiple aircraft (with associated initial trajectories and speeds), environmental variables (such as obstructions and visibility conditions), and division of sectors or airspace between the different students. In addition to updating global and local variables (also described above in connection with FIG. 5), process 600 may control the exchange of information between the students (e.g., the history of actions taken by a student, or status information for an aircraft that has passed from the sector of one student to another student's airspace). The method may also determine when the team simulation is complete by evaluating whether certain conditions have been satisfied. Exemplary conditions include checking whether all aircraft have been guided to their respective destinations, or whether the students' actions will prevent all aircraft from being safely guided to their respective destinations.

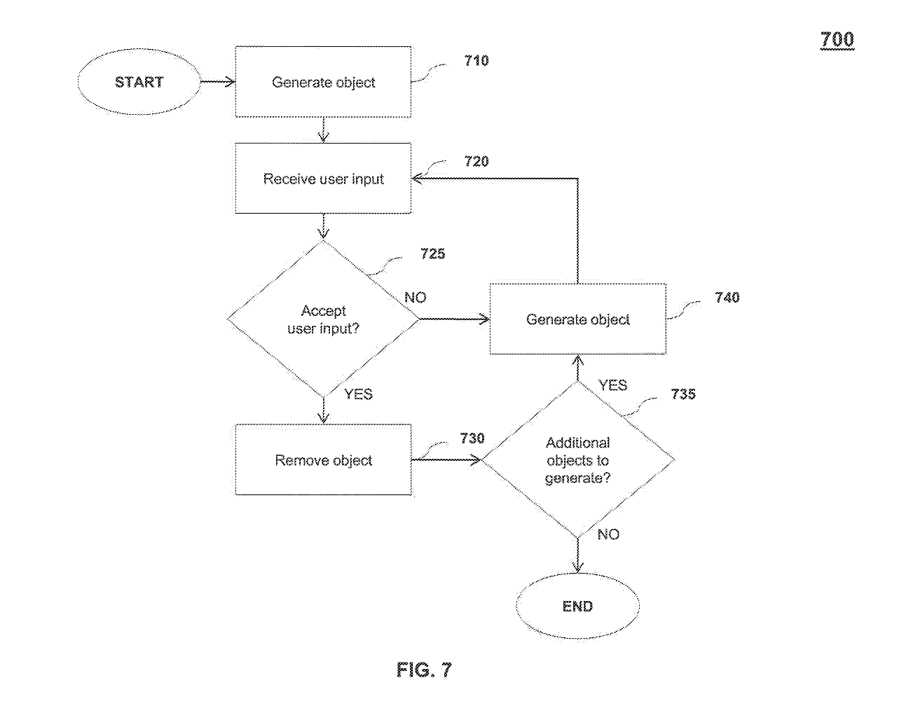

FIG. 7 is a flow diagram illustrating an example of a process 700 for generating and updating a set of objects in a training application or software program, based on user input. The training application may be executed on one or more devices 110a-110d or executed by server 105. In some embodiments, modules of the training application may be provided by one or more devices 110a-110d in conjunction with server 105.

At step 710, the training application may generate an object. The object may include information from a data set, and the information may be used, for example, to test or quiz a user. The training application may then receive user input at step 720. The user input may be in any of a number of formats, including, for example, text input, voice input, or selection of an embedded object. At step 725, the training application may evaluate the received user input. For example, the content of the user input may be checked against a predetermined set of acceptable inputs, such as, for example, correct answers to a question or accurate syntax. If the user input is accepted (e.g., because the user correctly answered a question), the training application may remove the generated object at step 730 and make a determination at step 735 as to whether additional objects to generate are available. If this determination is made in the affirmative, an additional object may be generated at step 740 and process 700 returns to step 720; Otherwise, process 700 ends. Alternatively, if the user input is not accepted at step 725 (e.g., because the user did not supply a correct input or use appropriate syntax), process 700 proceeds to step 740. For example, the generation of an object at step 740 may be based on, for example, an evaluation of the user's previous inputs. As an example, a user's pattern of incorrect inputs may prompt generation of an object related to the subject matter of the incorrect inputs, in order to reinforce material that a user may be weak on.

According to process 700, the training application may provide an error-based learning scheme to facilitate student knowledge retention. For example, when a student using a training application correctly answers a question, the training application may remove the item from the data set that the student is being tested on. The training application may repeatedly test the student on incorrect answers, however, until the student provides a sufficient level of correct answers.

The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. For example, the described implementations include software, but systems and methods consistent with the disclosed embodiments be implemented as a combination of hardware and software or in hardware alone. Examples of hardware include computing or processing systems, including personal computers, servers, laptops, mainframes, micro-processors and the like. Additionally, although aspects of the disclosed embodiments are described as being stored in memory, one skilled in the art will appreciate that these aspects can also be stored on other types of computer readable media, such as secondary storage devices, for example, hard disks, floppy disks, or CD ROM, or other forms of RAM or ROM, USB media, DVD, or other optical drive media.

Computer programs based on the written description and disclosed methods are within the skill of an experienced developer. The various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets. One or more of such software sections or modules can be integrated into a computer system, e-mail, or browser software.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed processes may be modified in any manner, including by reordering steps and/or inserting or deleting steps. Its intended therefore, that the specification and examples be considered as illustrative only, with a true scope and spirit being indicated by the following claims and their full scope of equivalents.

What is claimed is:

1. A computer-implemented method for using speech to control the operation of a training application, the method comprising:
receiving audio data representing a response to a training exercise from an input source associated with a trainee;
processing the received audio data to determine the content of the audio data;
generating a command based on at least the processed audio data; and
processing the generated command to control the operation of the training application.

2. The method of claim 1, wherein the received audio data corresponds to an instruction spoken by the trainee.

3. The method of claim 2, wherein processing the received audio data comprises:
comparing the instruction to words stored in a lookup table to determine whether the instruction is a valid instruction.

4. The method of claim 3, further comprising:
determining whether the result of the comparison exceeds a predetermined confidence level.

5. The method of claim 3, further comprising:
determining that the instruction does not correspond to any of the words stored in the lookup table; and
notifying the trainee that the instruction is invalid.

6. The method of claim 1, wherein processing the generated command comprises at least one of:
increasing or decreasing the speed of an aircraft in the training application;
modifying the direction of travel of the aircraft; and
raising or lowering the altitude of the aircraft.

7. An electronic device for using speech to control the operation of a training application, the device comprising:
a memory storing one or more instructions; and
a processor configured to execute the one or more instructions to perform operations comprising:
receiving audio data representing a response to a training exercise from an input source associated with a trainee;
processing the received audio data to determine the content of the audio data;
generating a command based on at least the processed audio data; and
processing the generated command to control the operation of the training application.

8. The electronic device of claim 7, wherein the received audio data corresponds to an instruction spoken by the trainee.

9. The electronic device of claim 8, wherein processing the received audio data comprises:
comparing the instruction to words stored in a lookup table to determine whether the instruction is a valid instruction.

10. The electronic device of claim 9, wherein the processor is further configured to execute the one or more instructions to perform:
determining whether the result of the comparison exceeds a predetermined confidence level.

11. The electronic device of claim 9, wherein the processor is further configured to execute the one or more instructions to perform operations comprising:
determining that the instruction does not correspond to any of the words stored in the lookup table; and
notifying the trainee that the instruction is invalid.

12. The electronic device of claim 7, wherein processing the generated command comprises at least one of:
increasing or decreasing the speed of an aircraft in the training application;
modifying the direction of travel of the aircraft; and
raising or lowering the altitude of the aircraft.

13. A computer-implemented method for executing a training application involving a plurality of trainees, wherein the plurality of trainees are associated with a plurality of electronic devices, each of the electronic devices configured to execute the training application, the method comprising:
connecting the plurality of trainees to a shared training application using the plurality of electronic devices, wherein each of the electronic devices executes the shared training application and stores a plurality of local objects describing a plurality of states of the associated trainee;
generating an interactive environment within the shared application, wherein the interactive environment comprises a plurality of global objects describing a plurality of states of the interactive environment;
updating a value of one or more of the global objects;
determining whether conditions for terminating the shared application have been met;
updating a value of one or more of the local objects; and
exchanging data between the electronic devices based on at least the updated local objects.

14. The method of claim 13, wherein the interactive environment is generated based on at least one of: airspace volume data, route data, fixes, and airline data.

15. The method of claim 13, wherein generating the interactive environment comprises:
performing 3D geometric analysis on the interactive environment to determine that the interactive environment is valid.

16. The method of claim 13, wherein the plurality of global objects describes at least one of: aircraft status information, aircraft identification information, and environmental information.

17. The method of claim 13, wherein the plurality of local objects corresponding to a trainee describes at least one of: the history of actions performed by the trainee, the currently available actions for the trainee, and the status of input and output variables for the trainee.

18. The method of claim 13, wherein determining whether conditions for terminating the shared application have been met comprises:
comparing one or more values of the plurality of global objects against one or more values included in a set of rules used to determine whether execution of the training application has completed.

19. The method of claim 13, wherein the training application is one of a distributed vectoring application or a team aircraft simulation.

20. The method of claim 13, wherein generating the interactive environment comprises generating at least one of:
one or more aircraft with associated initial trajectories and speeds;
one or more environmental obstructions;
one or more visibility conditions; and
a division of airspace among the plurality of trainees.
